(19) United States
(12) Patent Application Publication
(10) Pub. No.: US 2022/0303394 A1
(43) Pub. Date: Sep. 22, 2022

(54) MAPPING OF TELECOMMUNICATIONS SOFT CLIENT INPUT TO FEATURE ACCESS CODES OF A TELECOMMUNICATIONS SERVICE

(71) Applicant: Avaya Management L.P., Durham, NC (US)

(72) Inventor: Paul Roller Michaelis, Louisville, CO (US)

(21) Appl. No.: 17/208,760

(22) Filed: Mar. 22, 2021

(51) Int. Cl. H04M 7/12; H04L 29/06; H04Q 3/00; H04M 3/42

(52) U.S. Cl. CPC H04M 7/1295; H04L 65/1069; H04Q 3/0033; H04M 3/42153; H04M 2207/12

(57) ABSTRACT

The technology disclosed herein enables user input mapping to Feature Access Codes (FACs) of a telecommunications soft client. In a particular embodiment, a method includes, in a user system executing a telecommunications soft client, identifying a Feature Access Code (FAC) that, when sent to a telecommunications service compatible with the telecommunications soft client, triggers an action in the telecommunications service on behalf of the telecommunication soft client. The method further includes mapping a definition of user input to the FAC and, in response to receiving, from a user, user input defined by the definition, sending the FAC to the telecommunications service.

### TECHNICAL BACKGROUND

Software applications exist that allow personal computers to be used as real-time telecommunication endpoints (commonly referred to as “soft clients”). Examples include Skype, Cisco Jabber, and Avaya IX Workplace. With many soft clients, a function performed by a client itself may be triggered by interaction with a user interface of the client (e.g., selecting a displayed menu option). Although, especially in business environments, it is common for telecommunication services to support more functions than can reasonably be incorporated in a soft client user interface. To access those functions, users rely on what are commonly referred to as Feature Access Codes (FACs). With a standard telephone device, a twelve-button dial pad that a user operates to enter telephone numbers may instead be used to enter FACs as command-specific button-press sequences that are received and acted upon by the telecommunications service. A telecommunications soft client may emulate that dial pad on a Graphical User Interface (GUI) to allow for similar FAC entry but still requires user to remember the particular FACs supported by the telecommunications service. Moreover, using the emulated dial pad can be cumbersome.

### SUMMARY

The technology disclosed herein enables user input mapping to Feature Access Codes (FACs) of a telecommunications soft client. In a particular embodiment, a method includes, in a user system executing a telecommunications soft client, identifying a Feature Access Code (FAC) that, when sent to a telecommunications service compatible with the telecommunications soft client, triggers an action in the telecommunications service on behalf of the telecommunication soft client. The method further includes mapping a definition of user input to the FAC and, in response to receiving, from a user, user input defined by the definition, sending the FAC to the telecommunications service.

In some embodiments, identifying the FAC includes querying a server for FACs compatible with the telecommunications service and/or FACs associated with a task assigned to the user.

In some embodiments, mapping the definition includes receiving the definition from the user. In those embodiments, the method may include presenting a list of FACs available to the user and, before receiving the definition from the user, receiving a user selection of the FAC from the list of FACs.

In some embodiments, the user input may be one of a keyboard shortcut, a mouse gesture, a touchscreen gesture, or a voice command.

In some embodiments, the method includes identifying another Feature Access Code (FAC) that, when sent to another telecommunications service compatible with the telecommunications soft client, triggers the action in the other telecommunications service on behalf of the telecommunication soft client. In those embodiments, the method also includes mapping the definition to the other FAC and, in response to receiving the user input from the user a second time, sending the other FAC to the other telecommunications service.

In some embodiments, the method includes saving the mapping to a user profile of the user.

In some embodiments, sending the FAC includes emulating a dual tone multi frequency (DTMF) signal for the FAC or transferring a control message indicating the FAC in a telecommunications session protocol used by the telecommunications service.

In another embodiment, an apparatus is provided having one or more computer readable storage media and a processing system operatively coupled with the one or more computer readable storage media. Program instructions stored on the one or more computer readable storage media, when read and executed by the processing system, direct the processing system to: execute a telecommunications soft client and identify a Feature Access Code (FAC) that, when sent to a telecommunications service compatible with the telecommunications soft client, triggers an action in the telecommunications service on behalf of the telecommunication soft client. The program instructions further direct the processing system to map a definition of user input to the FAC and, in response to receiving, from a user, user input defined by the definition, send the FAC to the telecommunications service.

### BRIEF DESCRIPTION OF THE DRAWINGS

FIG. 1 illustrates an implementation for mapping Feature Access Codes to user input into a telecommunications soft client.

FIG. 2 illustrates an operation to map Feature Access Codes to user input into a telecommunications soft client.

FIG. 3 illustrates an operational scenario for mapping Feature Access Codes to user input into a telecommunications soft client.

FIG. 4 illustrates an implementation for mapping Feature Access Codes to user input into a telecommunications soft client.

FIG. 5 illustrates an operational scenario for mapping Feature Access Codes to user input into a telecommunications soft client.

FIG. 6 illustrates another operational scenario for mapping Feature Access Codes to user input into a telecommunications soft client.

FIG. 7 illustrates a soft client window for mapping Feature Access Codes to user input into a telecommunications soft client.

FIG. 8 illustrates a computing architecture for mapping Feature Access Codes to user input into a telecommunications soft client.

### DETAILED DESCRIPTION

The telecommunications soft clients of the examples herein enable mapping of user input (e.g., shortcuts) to telephony functions performed in a telecommunications service. These telephony functions may include voicemail functions, call forwarding functions, privacy functions, call transfer functions, or any other type of telephony function that may be handled off-client in a telecommunications service. Each function, or more specifically, each action for a function may be controlled by a Feature Access Code (FAC). A FAC is a predefined sequence of characters that, when received by a telecommunications service, triggers an action by the telecommunications service. A FAC may be transmitted in an out of band message (e.g., a control message outside of the exchange of user communications) or may be transmitted in band, as is the case with dual-tone multi-frequency (DTMF) signaling. For example, if using a traditional desk phone with a number pad, a user may pick up the receiver and dial a specific sequence (e.g., #76). Tones associated with that sequence may be transmitted in the same channel as the user's voice and then are recognized by the telecommunications service to trigger an action at the telecommunications service. Alternatively, a control message indicating the sequence may be transmitted, which may be the case in packet-based communication sessions (although, packet-based communications can also carry tones like DTMF signaling on the voice channel). While a traditional telecommunications soft client can emulate the above-discussed number pad, or other input apparatus, and the number pad's functionality on the user system in which the client is executing (e.g., by displaying one on a GUI), the telecommunications soft clients herein map FACs to defined user inputs so that a user need not remember a particular FAC and need not deal with the emulated pad to enter the FAC, which may be cumbersome.

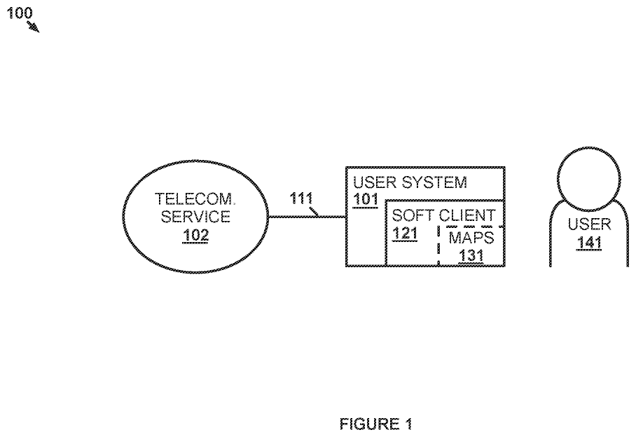

FIG. 1 illustrates an implementation 100 for mapping Feature Access Codes to user input into a telecommunications soft client. Implementation 100 includes user system 101 and telecommunications service 102. User system 101 and telecommunications service 102 communication over communication link 111. User system 101 may be a telephone, laptop, personal computer, tablet computer, or some other type of user operable computing system. Communication link 111 may be wired and/or wireless. Communication link 111 is shown as a direct link but may include intervening systems, networks, and/or devices. Telecommunications service 102 includes one or more computing systems that provide telephony features to user system 101. Telecommunications service 102 may also include one or more networks, such as a circuit switched telephone network, local area packet network, wide area network (e.g., the Internet), or some other type of network over which telecommunications may be carried including combinations thereof. As such, communication link 111 may, at least in part, traverse a network of telecommunications service 102.

In operation, user system 101 executes telecommunications soft client 121. User 141 operates user system 101, in part, by interacting with user interfaces of telecommunications soft client 121. Telecommunications soft client 121 allows user 141 to telecommunicate with one or more other users, via their respective user systems over communication sessions facilitated by telecommunications service 102. The other user systems may also execute a telecommunications soft client like telecommunications soft client 121 or may communicate in some other manner (e.g., may be a circuit switched telephone or other type of dedicated telephony device). The communication sessions may carry real-time voice, video, text, and/or some other type of user communications. Telecommunications soft client 121 also allows user 141 to access features of telecommunications service 102 in addition to facilitating the above communication sessions. For example, the features may include call forwarding, voicemail, call blocking, call transfer, or some other telephony related function. To receive instructions directing telecommunications service 102 to perform actions with respect to the features, telecommunications service 102 associates each action with a FAC. Upon receiving a FAC from user system 101, telecommunications service 102 performs the action associated with the received FAC.

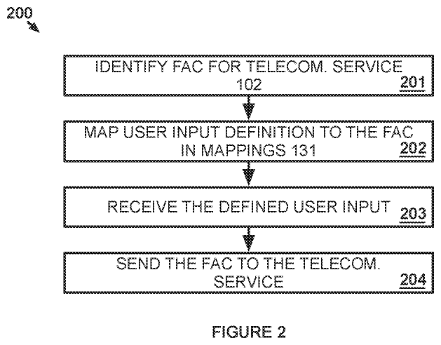

FIG. 2 illustrates operation 200 to map Feature Access Codes to user input into a telecommunications soft client. In operation 200, user system 101 at the direction of telecommunications soft client 121 executing thereon identifies a FAC that, when sent to telecommunications service 102, triggers an action in telecommunications service 102 on behalf of telecommunications soft client 121 (201). The FAC may be identified by telecommunications soft client 121 querying telecommunications service 102 for the FAC, querying another system (e.g., an enterprise administrative server) for the FAC, receiving the FAC in user input from user 141, obtaining the FAC from FACs preloaded into telecommunications soft client 121, or the FAC may be identified from some other source. In some examples, telecommunications soft client 121 may be compatible only with telecommunications service 102 (e.g., may be a client supplied by telecommunications service 102) or telecommunications soft client 121 may be compatible with one or more additional telecommunications services. When identifying the FAC, telecommunications soft client 121 may also determine the action associated with the FAC (i.e., the action triggered by the FAC), which may aid user 141 when defining user input corresponding to the FAC. For example, with knowledge of the associated action, telecommunications soft client 121 may present user 141 with the action in addition to (or in place of) the FAC. This allows user 141 to likewise know which action is being mapped to which user input, as described below. Otherwise, user 141 will have to determine the action from memory or some other source (e.g., a reference table of FACs and corresponding actions for telecommunications service 102).

Telecommunications soft client 121 maps a definition of user input to the FAC (202). The definition may be received from user 141 (e.g., through a FAC/user input definition interface of telecommunications soft client 121), may be a default definition (e.g., a default definition stored locally in telecommunications soft client 121, retrieved from telecommunications service 102, or from some other source), may be received from another system (e.g., an administrative server), or may be obtained from some other source. The user input that is defined by the definition may be a sequence or combination of keyboard key presses (e.g., Control+F4 or shift+alt+T), may be a touchpad/touchscreen gesture (e.g., a combination/pattern of swipes, taps, etc.), a mouse gesture and/or button press combination, a voice command, a body movement (e.g., hand motion captured by a camera of user system 101), or may be defined in terms of some other type of input into a user system—including combinations thereof. In some examples, the definition may be supplied to telecommunications soft client 121 by user 141 providing an example of the user input being defined in to user system 101. For instance, if the definition is a key combination, then the user may provide the key combination when telecommunications soft client 121 indicates it is ready to receive the definition (e.g., user 141 may press control+F4 to demonstrate the desired combination). In this example, telecommunications soft client 121 stores the mapping of the definition to the FAC in mappings 131. Mappings 131 is a data structure that may also store other mappings of other definitions of user inputs to other FACs.

At a time after the mapping was created, user system 101 receives the defined user input from user 141 (203). The user input may be directed specifically to telecommunications soft client 121 (e.g., telecommunications soft client 121 may be the application currently having focus on user system 101) or the user input may be global user input that is passed to telecommunications soft client 121 from anywhere in the operating system, including when another application is the focus. In some examples, user 141 may indicate within mappings 131 whether they want the defined user input to be global user input. In response to receiving the defined user input, telecommunications soft client 121 sends the FAC to telecommunications service 102 (204). In this example, since mappings 131 store the FAC corresponding to the received input, telecommunications soft client 121 references mappings 131 to identify the FAC. The FAC is sent to telecommunications service 102 using whatever convention telecommunications service 102 requires. For example, if telecommunications service 102 requires the FAC be sent using DTMF, then telecommunications soft client 121 directs user system 101 to emulate a DTMF signal representing the FAC to telecommunications service 102 over communication link 111. In an alternative example, if telecommunications service 102 uses a packet based protocol with control messages, then the FAC may be transferred in one of those control messages. Upon receipt of the FAC, telecommunications service 102 performs the action associated with the received FAC in the same manner it would if user 141 had not used the defined user input (e.g., if user 141 input the FAC into a number pad).

Advantageously, rather than having to remember the specific FAC, operation 200 allows user 141 to instead remember a user input definition, which may be easier to remember. Likewise, the defined user input may also be easier to provide to user system 101 instead of having to enter the FAC manually (e.g., instead of navigating telecommunications soft client 121 to a specific interface area, such as a displayed dial pad, into which the FAC can be entered manually), which may be cumbersome. In some cases, the user input definitions may also constitute a security feature whereby only users (e.g., user 141) knowing the user input definition corresponding to a particular FAC can trigger that FAC. In those scenarios, telecommunications soft client 121 may not provide a means for entering FACs (e.g., dial pad) other than the defined user input.

In some examples, mappings 131 may be stored in a user profile associated with user 141. Even if other users log into telecommunications soft client 121 or user system 101 (e.g., user system 101 may be a shared computer), when user 141 logs into telecommunications soft client 121, mappings 131 may be retrieved from the user profile so that user 141 can continue to use the same mappings as before. Other users of user system 101 may also have their own mappings stored in their own user profiles. In some cases, the user profiles may be stored remotely (e.g., on an administrative system or in telecommunications service 102) so that mappings 131 can be retrieved for user 141 even if user 141 logs into a telecommunications soft client on a different user system.

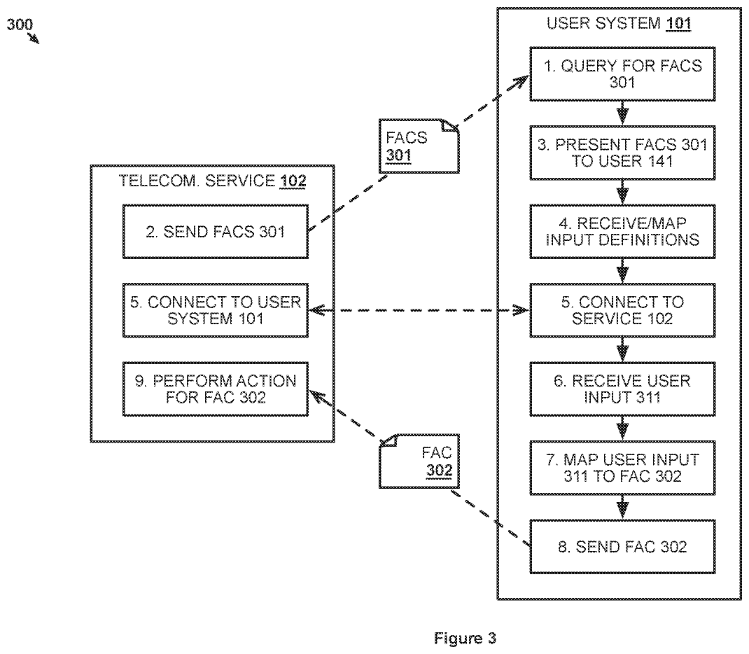

FIG. 3 illustrates operational scenario 300 for mapping Feature Access Codes to user input into a telecommunications soft client. Operational scenario 300 includes more details regarding how user system 101 and telecommunications service 102 may interact to implement operation 200. In operational scenario 300, user system 101 queries telecommunications service 102 at step 1 for FACs 301 and, responsive to that query, telecommunications service 102 sends FACs 301 at step 2 to user system 101. User system 101 may query for FACs 301 automatically or may query for FACs 301 at the request of user 141 (e.g., in response to user 141 opening a GUI area of telecommunications soft client 121 where user input definitions can be provided for FACs 301). FACs 301 may include all FACs recognizable by telecommunications service 102 or a subset of all FACs, such as those FACs that are associated with (e.g., authorized for) user system 101 and/or user 141, those FACs that are associated with a particular task or job assignment being performed by user 141 (e.g., sales, tech support, etc.), or some other manner in which the subset may be defined. User system 101 may query for a specific subset or telecommunications service 102 may determine which subset of FACs user system 101 should and/or is authorized to receive. While telecommunications service 102 itself provides the FACs in operational scenario 300, other systems may provide the FACs in alternative examples, such as the administrative system in the examples below.

User system 101 presents FACs 301 to user 141 at step 3 to inform user 141 about the FACs available to user 141. For example, user system 101 may display FACs 301 to user 141, such as in a GUI area (e.g., window of telecommunications soft client 121) where user input can be defined for each of FACs 301. Other manners of presenting information may also be used, such as user system 101 audibly reading FACs 301 to user 141. Presentation of FACs 301 may include presenting only FACs 301 themselves or may include other associated information, such as an action/feature associated with each particular one of FACs 301. After presenting FACs 301 to user 141, user system 101, at step 4, receives user input definitions for one or more of FACs 301 from user 141 and maps each of the user input definitions to its corresponding one of FACs 301 in mappings 131. For example, user 141 may select one of FACs 301 and provide a user input definition that user 141 wants mapped to that selected FAC. User 141 may similarly select and provide user input definitions for other ones of FACs 301. In some examples, if there are ones of FACs 301 for which user 141 does not explicitly provide a user input definition, then a default user input definition may be mapped automatically (e.g., a definition predefined in telecommunications soft client 121) and presented to user 141, or no user input definition may be mapped to those ones of FACs 301. If no user input definition is mapped to a particular FAC, then user 141 will have to manually input the FAC (e.g., into an on-screen dial pad of telecommunications soft client 121) should user 141 want to trigger the action associated with the unmapped FAC.

At some time after mapping the user input definitions, user system 101 and telecommunications service 102 connect to each other at step 5 for telecommunications service 102 to provide a telecommunications service to user system 101. The telecommunications service may be to establish a new communication session (either incoming or outgoing) between user system 101 and another user system, may be to access voicemail for user 141, may be to modify service settings, or may be some other type of telecommunications service. After establishing the connection, user system 101 receives user input 311 at step 6 from user 141. User system 101 references mappings 131 to determine, at step 7, that user input 311 matches the user input definition mapped to FAC 302 of FACs 301. In response to identifying FAC 302, user system 101 sends FAC 302 at step 8 to telecommunications service 102. As noted above, FAC 302 may be sent as a DTMF signal, a control message, or using some other FAC signaling convention used by telecommunications service 102. In response to receiving FAC 302, telecommunications service 102 performs the action corresponding to FAC 302 at step 9. For example, if FAC 302 corresponds to the action of enabling call forwarding, then telecommunications service 102 enables call forwarding on behalf of user system 101. Thus, in operational scenario 300, rather than user 141 having to enter FAC 302 manually into telecommunications soft client 121, user 141 provides user input 311, which may be easier for user 141 to remember and less cumbersome to enter.

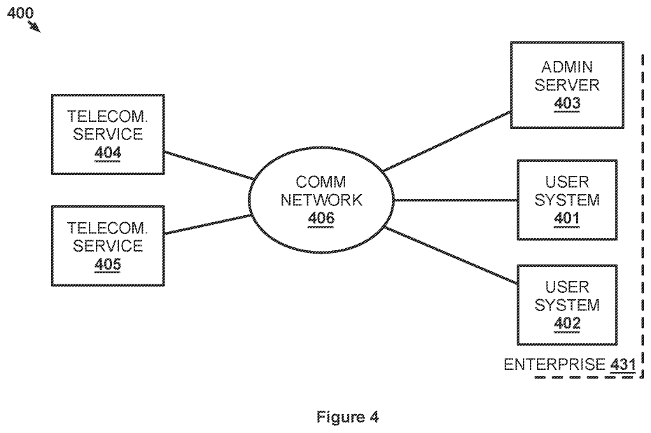

FIG. 4 illustrates an implementation 400 for mapping Feature Access Codes to user input into a telecommunications soft client. Implementation 400 includes user system 401, user system 402, administrative server 403, telecommunications service 404, telecommunications service 405, and communications network 406. Communication network 406 includes one or more local area networks and/or wide area computing networks, including the Internet, over which computing systems communicate. Endpoints 401-402 may each comprise a telephone, laptop computer, desktop workstation, tablet computer, conference room system, or some other type of user operable computing device.

In operation, user system 401, user system 402, and administrative server 403 are all systems of enterprise 431. For example, the users operating user system 401 and user system 402 may be employees of, or otherwise are associated with, enterprise 431. Administrative server 403 is used by enterprise 431 to handle at least the distribution of FACs to user systems of enterprise 431. An administrative user may instruct administrative server 403 regarding which user systems receive which FACs, which may be based on the user systems themselves or the users operating those user systems. Telecommunications service 404 and telecommunications service 405 each provide telephony related services to user systems in enterprise 431. Telecommunications service 404 and telecommunications service 405 may provide all the same services (e.g., may be redundant to account for downtime) or at least one of the services provided may differ.

To communicate with telecommunications service 404 and telecommunications service 405, user system 401 and user system 402 execute a telecommunications soft client similar to telecommunications soft client 121 discussed above. In this case, the telecommunications soft client enables user system 401 and user system 402 to access services from both telecommunications service 404 and telecommunications service 405. Thus, while the scenarios below reference actions taken by user system 401 and user system 402, it should be understood that those action are done at the direction of telecommunications soft clients executing thereon.

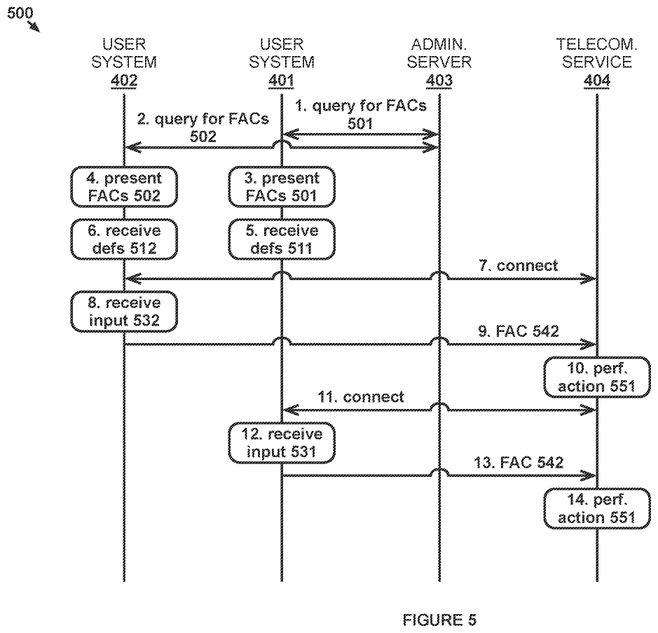

FIG. 5 illustrates operational scenario 500 for mapping Feature Access Codes to user input into a telecommunications soft client. Operational scenario 500 is an example of how different user input definitions may be assigned to the same FAC by users of different user systems. As such, different user input may be used between user system 401 and user system 402 to send the same FAC to one of telecommunications service 404 and telecommunications service 405.

In operational scenario 500, user system 401 queries administrative server 403 at step 1 for FACs 501 and user system 402 queries administrative server 403 at step 2 for FACs 502. The queries may be explicit queries for the FACs or administrative server 403 may push FACs 501 and FACs 502 upon receiving indication that telecommunications soft clients are executing (e.g., the telecommunications soft clients may log into administrative server 403 on behalf of their users). FACs 501 are FACs that are available for use by user system 401 and FACs 502 are FACs that are available for use by user system 402. While administrative server 403 may be aware of all possible FACs for telecommunications service 404 and telecommunications service 405, FACs 501 and FACs 502 include only those FACs that are relevant to user system 401 and user system 402. An administrative user may instruct (e.g., provide criteria to) administrative server 403 about which FACs should go to which user systems based on the user systems themselves or characteristics of the users of the user systems. For example, in their respective queries, user system 401 and user system 402 may indicate to administrative server 403 who their respective users are and, responsively, administrative server 403 may provide FACs 501 and FACs 502 based on the users (e.g., based on the user's job function, seniority, and/or some other criteria related to user characteristics). After user system 401 and user system 402 have queried administrative server 403 once (e.g., on first execution, after a user first requests the FACs, etc.), then user system 401 and user system 402 may, on occasion (e.g., after the telecommunications soft client updates), perform steps 1 and 2 again to receive any updates to FACs 501 and FACs 502. In other examples, administrative server 403 may push those updates to user system 402 and user system 401.

After FACs 501 and FACs 502 are received, user system 401 presents FACs 501 at step 3 to its user and user system 402 presents FACs 502 at step 4 to its user. In this example, each FAC is identified to the user based on the corresponding action that the FAC triggers in telecommunications service 404. The actual FAC may also be presented. FACs 501 and FACs 502 may be presented in response to receiving FACs 501 and FACs 502 or may not be presented until a user requests that they be presented (e.g., navigates to a GUI area within the telecommunications soft client where available FACs are displayed and where user input definitions corresponding to those FACs can be provided). In some examples, such as situations where a user is visually impaired, FACs may be read aloud to the user (e.g., using a voice synthesizer in user system 401 or user system 402). After presentation of FACs 501 and FACs 502, user system 401 receives user input definitions 511 at step 5 from its user and user system 402 receives user input definitions 512 at step 6 from its user. In this example, FACs 501 and FACs 502 both include FAC 542 that, when transferred to telecommunications service 404, directs telecommunications service 404 to perform action 551. Likewise, in this example, user input definitions 511 and user input definitions 512 both at least include user input definition that defines user input (e.g., key combination, voice command, mouse gesture, etc.) corresponding to (i.e., mapped to) FAC 542. In this case, user input definitions 511 map user input 531 to FAC 542 and user input definitions 512 map user input 532 to FAC 542. Any of FACs 501 and FACs 502 that are not mapped to definitions in user input definitions 511 and user input definitions 512, respectively, may simply be left unmapped (i.e., are required to still be input manually) or may be mapped to default user input definitions. In some cases, administrative server 403 provides the default definitions or the default definitions may be predefined in the telecommunications soft clients of user system 401 and user system 402. In some examples, even if the user does not provide a user input definition for a particular FAC in user input definitions 511 or user input definitions 512, the user may still be able to provide a user input definition at a later time. For instance, the user may realize at a later time that they would prefer having a user input definition mapped to the FAC and may navigate the GUI of the telecommunications soft client back to the definition input area (e.g., window) for doing so.

At some point after receiving user input definitions 512, user system 402 connects at step 7 to telecommunications service 404. Connecting to telecommunications service 404 may comprise user system 402 attempting to access a specific service/feature of telecommunications service 404 (e.g., place a call or access voicemail) or user system 402 may simply connect to telecommunications service 404 for the purposes of sending a FAC (in this latter example, step 8 may occur before the connection at step 7). User system 402 receives user input 532 from its user at step 8 and determines that user input 532 is mapped to FAC 542 by user input definitions 512. In this example, user input 532 may be received anytime that the telecommunications soft client on user system 402 is the focus application (i.e., is not running in the background) in order for the telecommunications soft client to recognize that user input 532 is directed thereto. Although, in other examples, user input 532 may be global user input that is routed to the telecommunications soft client regardless of where in the operating system the user is focused (e.g., when a different application is the focus). Global user input, therefore, allows the user to interact with another application while still being able to take advantage of user input 532.

In response to receiving user input 532, user system 402 sends FAC 542 at step 9 to telecommunications service 404, which performs action 551 at step 10 responsively. For example, action 551 may be playing new voicemail and telecommunications service 404 plays new voicemail for the user of user system 402 over the connection with user system 402 in response to receiving FAC 542. Telecommunications service 404 performs action 551 in the same manner it would had user input 532 not been used to trigger the transfer of FAC 542 because telecommunications service 404 is unaware of what triggered its receipt of FAC 542.

Like what occurred in relation to user system 402 in steps 7-10 above, at some point after receiving user input definitions 511, user system 401 connects at step 11 to telecommunications service 404. User system 401 receives user input 531 from its user at step 12 and determines that user input 531 is mapped to FAC 542 by user input definitions 511. User input 531 may be different from user input 532 because the user of user system 401 may have different user input mapping preferences than the user of user system 402. Like user input 532, user input 531 may also be global user input in some examples. In response to receiving user input 531, user system 401 sends FAC 542 at step 13 to telecommunications service 404, which performs action 551 at step 14 responsively. In the example where action 551 is playing new voicemail, telecommunications service 404 plays new voicemail for the user of user system 401 over the connection with user system 401 in response to receiving FAC 542. Telecommunications service 404 performs action 551 in the same manner it would had user input 531 not been used to trigger the transfer of FAC 542 because telecommunications service 404 is unaware of what triggered its receipt of FAC 542. Thus, user system 402 and user system 401 can both use different user input (i.e., user input 531 and user input 532) to trigger the same FAC (i.e., FAC 542).

While the steps performed relative to user system 401 and user system 402 above are shown as occurring at substantially the same time, it should be understood that the steps can occur at any time and are not dependent upon one another. For instance, steps 1, 3, 5, and 11-14 may occur on a different day then the other steps.

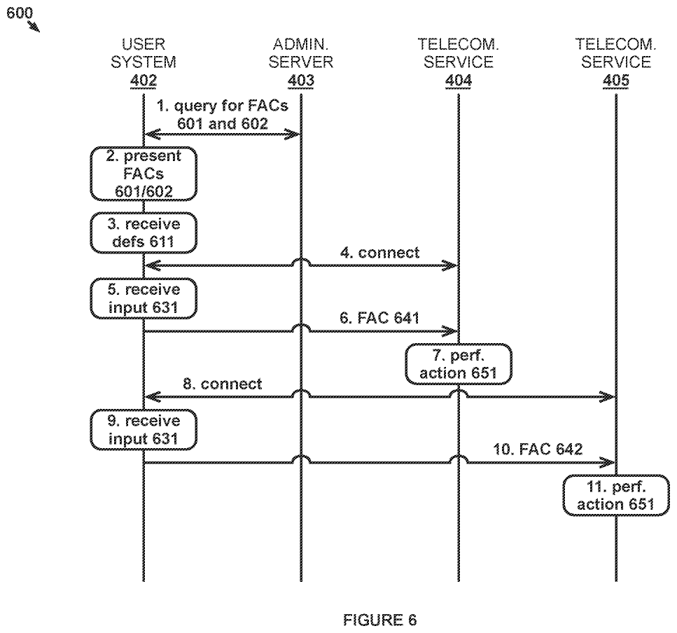

FIG. 6 illustrates operational scenario 600 for mapping Feature Access Codes to user input into a telecommunications soft client. Operational scenario 600 is an example of how telecommunications service 404 and telecommunications service 405 use different FACs for the same action. In operational scenario 600, user system 402 queries administrative server 403 at step 1 for FACs 601 and FACs 602 and receives FACs 601 and FACs 602 responsively. FACs 601 are FACs available to user system 402 for use with telecommunications service 404 and FACs 602 are FACs available to user system 402 for use with telecommunications service 405. Even if one or more of FACs 601 and FACs 602 correspond to a same, or similar, action in telecommunications service 404 and telecommunications service 405, the FACs for a particular action may be different between telecommunications service 404 and telecommunications service 405. For example, the FAC to enable call forwarding may be *54 on telecommunications service 404 while on telecommunications service 405 the FAC is #32.

User system 402 presents FACs 601 and FACs 602 to its user at step 2 in a similar manner to how FACs 502 were presented above. User system 402 may indicate to the user which FACs are for which of telecommunications service 404 and telecommunications service 405 (e.g., FACs 601 may be presented in a different tab that FACs 602). In some examples, user system 402 may present a single FAC indicator for an action shared by telecommunications service 404 and telecommunications service 405 (e.g., may display a single identifier for the action triggered by two different FACs between telecommunications service 404 and telecommunications service 405 rather than displaying one for each). For instance, both telecommunications service 404 and telecommunications service 405 may support call forwarding enabling via different FACs and user system 402 may present a single “call forwarding” identifier for which the user of user system 402 can map a user input definition.

After presenting FACs 601 and FACs 602, user system 402 receives user input definitions 611 at step 3 in a manner similar to receiving user input definitions 512 above. User input definitions 611 at least includes a user input definition that maps user input 631 to action 651. Action 651 is an action that both telecommunications service 404 and telecommunications service 405 perform. Telecommunications service 404 performs action 651 in response to FAC 641, which is included in FACs 601, and telecommunications service 405 performs action 651 in response to FAC 642, which is included in FACs 602. Thus, by mapping user input 631 to action 651, user input 631 is mapped to both FAC 641 and FAC 642.

After receiving user input definitions 611, user system 402 connects to telecommunications service 404 at step 4 and then receives user input 631 at step 5. Since telecommunications service 404 is currently connected to telecommunications service 404, user system 402 determines that user input 631 maps to FAC 641. FAC 641 is then sent to telecommunications service 404 at step 6 and telecommunications service 404 performs action 651 in response to receiving FAC 641. In other examples, user system 402 may determine to send FAC 641 to telecommunications service 404, rather than sending FAC 642 to telecommunications service 405, based on other factors. For instance, the GUI of the telecommunications soft client may be currently in an area dedicated to telecommunications service 404 even if no connection has yet to be made with telecommunications service 404 or the telecommunications soft client may not even be logged into telecommunications service 405 at the time user input 631 is received.

At a subsequent time, user system 402 also connects to telecommunications service 405 at step 8 and user system 402 again receives user input 631 at step 9. In this case, user system 402 is no longer connected to telecommunications service 404, so user system 402 determines that user input 631 is mapped to FAC 642 and sends FAC 642 to telecommunications service 405 at step 10. Telecommunications service 405 then performs action 651 in response to receiving FAC 642. Thus, while two different FACs needed to be sent to telecommunications service 404 and telecommunications service 405 respectively to perform action 651 thereat, the user of user system 402 only needs to remember user input 631 to trigger action 651.

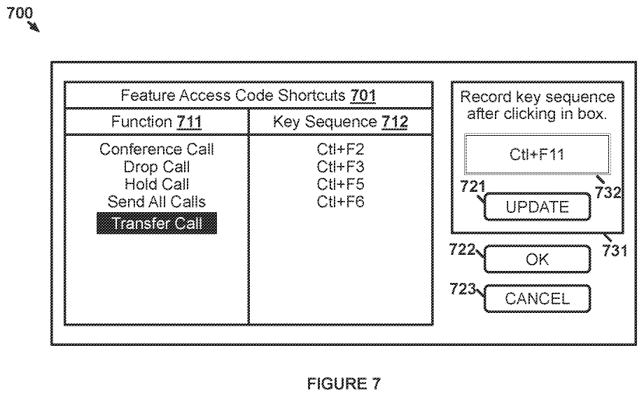

FIG. 7 illustrates soft client window 700 for mapping Feature Access Codes to user input into a telecommunications soft client. Soft client window 700 may be a window of telecommunications soft client 121 or of any other telecommunications soft client discussed herein. Soft client window 700 displays FAC shortcuts 701 which include functions list 711 and corresponding key sequences 712. Functions list 711 describes five actions that corresponding FACs will trigger in a telecommunications service to perform. FAC shortcuts 701 does not display the actual FAC for each of the actions in functions list 711 since a key sequence will be used by the user in place of manually entering the FAC, as described above. In this example, key sequences 712 represent the user input definitions described above. Each key sequence of key sequences 712 corresponds to the action in functions list 711 across from it. For instance, the “drop call” action corresponds to the key sequence of pressing control and F3 keys at the same time. As such, if the user was to press control and F3 at the same time, the telecommunications soft client will transfer the FAC corresponding to the drop call action.

The “transfer call” action in functions list 711 does not yet have a corresponding key sequence. However, the user has selected the transfer call action to highlight it for assignment of a key sequence. Sequence recording area 731 includes definition box 732 where the user can provide their desired key sequence for the transfer call action. In this example, the user has input control plus F11 key into definition box 732. When the user presses update button 721, “Ctl+F11” will populate the space in key sequences 712 across from the transfer call action. Upon the user then selecting OK button 722, any changes the user made to key sequences 712 are saved and soft client window 700 is closed so the user can continue to use the telecommunications soft client. In particular, if the user pressed control and F11 during a call, then the telecommunications soft client will send, to the telecommunications service, the FAC corresponding to the transfer call action, which will trigger the telecommunications service to transfer the call (or at least begin the process of transferring the call). Otherwise, the user may select cancel button 723 to close soft client window 700 while discarding any changes made (i.e., the transfer call action would continue to not have a corresponding key sequence in key sequences 712).

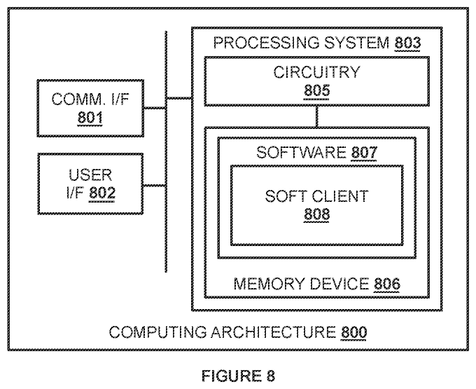

FIG. 8 illustrates computing architecture 800 for mapping Feature Access Codes to user input into a telecommunications soft client. Computing architecture 800 is an example computing architecture for user systems 101, 401, and 402, although user systems 101, 401, and 402 may use alternative configurations. Other computing systems herein, such as administrative server 403 or systems of telecommunications services 102, 404, and 405 may also use computing architecture 800. Computing architecture 800 comprises communication interface 801, user interface 802, and processing system 803. Processing system 803 is linked to communication interface 801 and user interface 802. Processing system 803 includes processing circuitry 805 and memory device 806 that stores operating software 807.

Communication interface 801 comprises components that communicate over communication links, such as network cards, ports, RF transceivers, processing circuitry and software, or some other communication devices. Communication interface 801 may be configured to communicate over metallic, wireless, or optical links. Communication interface 801 may be configured to use TDM, IP, Ethernet, optical networking, wireless protocols, communication signaling, or some other communication format—including combinations thereof.

User interface 802 comprises components that interact with a user. User interface 802 may include a keyboard, display screen, mouse, touch pad, or some other user input/output apparatus. User interface 802 may be omitted in some examples.

Processing circuitry 805 comprises microprocessor and other circuitry that retrieves and executes operating software 807 from memory device 806. Memory device 806 comprises a computer readable storage medium, such as a disk drive, flash drive, data storage circuitry, or some other memory apparatus. In no examples would a storage medium of memory device 806 be considered a propagated signal. Operating software 807 comprises computer programs, firmware, or some other form of machine-readable processing instructions. Operating software 807 includes telecommunications soft client 808. Operating software 807 may further include an operating system, utilities, drivers, network interfaces, applications, or some other type of software. When executed by processing circuitry 805, operating software 807 directs processing system 803 to operate computing architecture 800 as described herein.

In particular, telecommunications soft client 808 directs processing system 803 to identify a Feature Access Code (FAC) that, when sent to a telecommunications service compatible with the telecommunications soft client, triggers an action in the telecommunications service on behalf of the telecommunication soft client. Telecommunications soft client 808 also directs processing system 803 to map a definition of user input to the FAC. In response to receiving, from a user, user input defined by the definition, telecommunications soft client 808 directs processing system 803 to send the FAC to the telecommunications service.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method comprising:
in a user system executing a telecommunications soft client:
identifying a Feature Access Code (FAC) that, when sent to a telecommunications service compatible with the telecommunications soft client, triggers an action in the telecommunications service on behalf of the telecommunication soft client;
mapping a definition of user input to the FAC; and
in response to receiving, from a user, user input defined by the definition, sending the FAC to the telecommunications service.

2. The method of claim 1, wherein identifying the FAC comprises:
querying a server for FACs compatible with the telecommunications service.

3. The method of claim 1, wherein identifying the FAC comprises:
querying a server for FACs associated with a task assigned to the user.

4. The method of claim 1, wherein mapping the definition comprises:
receiving the definition from the user.

5. The method of claim 4, comprising:
presenting a list of FACs available to the user; and
before receiving the definition from the user, receiving a user selection of the FAC from the list of FACs.

6. The method of claim 1, wherein the user input comprises one of a keyboard shortcut, a mouse gesture, a touchscreen gesture, or a voice command.

7. The method of claim 1, comprising:
identifying another Feature Access Code (FAC) that, when sent to another telecommunications service compatible with the telecommunications soft client, triggers the action in the other telecommunications service on behalf of the telecommunication soft client;
mapping the definition to the other FAC; and
in response to receiving the user input from the user a second time, sending the other FAC to the other telecommunications service.

8. The method of claim 1, comprising:
saving the mapping to a user profile of the user.

9. The method of claim 1, wherein sending the FAC comprises:
emulating a dual tone multi frequency (DTMF) signal for the FAC.

10. The method of claim 1, wherein sending the FAC comprises:
transferring a control message indicating the FAC in a telecommunications session protocol used by the telecommunications service.

11. An apparatus comprising:
one or more computer readable storage media;
a processing system operatively coupled with the one or more computer readable storage media; and
program instructions stored on the one or more computer readable storage media that, when read and executed by the processing system, direct the processing system to:
execute a telecommunications soft client;
identify a Feature Access Code (FAC) that, when sent to a telecommunications service compatible with the telecommunications soft client, triggers an action in the telecommunications service on behalf of the telecommunication soft client;
map a definition of user input to the FAC; and
in response to receiving, from a user, user input defined by the definition, send the FAC to the telecommunications service.

12. The apparatus of claim 11, wherein to identify the FAC, the program instructions direct the processing system to:
query a server for FACs compatible with the telecommunications service.

13. The apparatus of claim 11, wherein to identify the FAC, the program instructions direct the processing system to:
query a server for FACs associated with a task assigned to the user.

14. The apparatus of claim 11, wherein to map the definition, the program instructions direct the processing system to:
receive the definition from the user.

15. The apparatus of claim 14, wherein the program instructions direct the processing system to:
present a list of FACs available to the user; and
before receiving the definition from the user, receive a user selection of the FAC from the list of FACs.

16. The apparatus of claim 11, wherein the user input comprises one of a keyboard shortcut, a mouse gesture, a touchscreen gesture, or a voice command.

17. The apparatus of claim 11, wherein the program instructions direct the processing system to:
identify another Feature Access Code (FAC) that, when sent to another telecommunications service compatible with the telecommunications soft client, triggers the action in the other telecommunications service on behalf of the telecommunication soft client;
map the definition to the other FAC; and
in response to receiving the user input from the user a second time, send the other FAC to the other telecommunications service.

18. The apparatus of claim 11, wherein the program instructions direct the processing system to:
save the mapping to a user profile of the user.

19. The apparatus of claim 11, wherein to send the FAC, the program instructions direct the processing system to:
emulate a dual tone multi frequency (DTMF) signal for the FAC.

20. One or more computer readable storage media having program instructions stored thereon that, when read and executed by a processing system, direct the processing system to:
execute a telecommunications soft client;
identify a Feature Access Code (FAC) that, when sent to a telecommunications service compatible with the telecommunications soft client, triggers an action in the telecommunications service on behalf of the telecommunication soft client;
map a definition of user input to the FAC; and
in response to receiving, from a user, user input defined by the definition, send the FAC to the telecommunications service.
